(19) United States
(12) Patent Application Publication
(10) Pub. No.: US 2023/0069613 A1
(43) Pub. Date: Mar. 2, 2023

(54) DRIVE APPARATUS

(71) Applicant: NIDEC CORPORATION, Kyoto (JP)

(72) Inventors: Shohei OSUGA, Kyoto (JP); Yoshiyuki AONO, Kyoto (JP)

(21) Appl. No.: 17/893,182

(22) Filed: Aug. 23, 2022

(30) Foreign Application Priority Data
Aug. 24, 2021 (JP) 2021-136177

(51) Int. Cl. F16H 57/04; H02K 5/20; H02K 7/00; H02K 7/08; H02K 7/116; H02K 9/193

(52) U.S. Cl. CPC F16H 57/0475; H02K 5/203; H02K 7/003; H02K 7/083; H02K 7/116; H02K 9/193; F16H 57/0424; F16H 57/043; F16H 57/045; F16H 57/0436; F16H 57/0457; F16H 57/0471; F16H 57/0415; F16H 57/0483; B60K 1/00

(57) ABSTRACT

A drive apparatus includes a motor having a rotor with a hollow motor shaft and a stator, a gear connected to the rotor, a housing including a motor housing accommodating the motor, and a gear housing at one side in an axial direction of the motor housing and accommodating the gear, and a passage. The gear includes a hollow gear shaft connected to one side in the axial direction of the motor shaft. The passage includes a first portion connecting the inside of the gear housing and the inside of the gear shaft, a second portion at least partially configured by the inside of the gear shaft and the inside of the motor shaft and connected to the first portion, a third portion connected to the second portion on the other side in the axial direction, and a first supply portion connected to the third portion and above the stator.

### CROSS-REFERENCE TO RELATED APPLICATIONS

The present invention claims priority under 35 U.S.C. § 119 to Japanese Patent Application No. 2021-136177 filed on Aug. 24, 2021, the entire content of which is incorporated herein by reference.

### FIELD OF THE INVENTION

The present invention relates to a drive apparatus.

### BACKGROUND

A drive apparatus including an oil supply passage for supplying oil is known. For example, as such a drive apparatus, there is a drive apparatus mounted on an electric vehicle.

In the drive apparatus as described above, for example, a plurality of oil supply passages for supplying oil to each part, such as an oil supply passage for supplying oil to the stator and an oil supply passage for supplying oil to the hollow shaft, may be provided. In such a case, it has been required that oil can be more efficiently supplied to each part.

### SUMMARY

One aspect of an exemplary drive apparatus of the present invention includes: a motor including a rotor rotatable about a center axis and a stator facing the rotor with a gap interposed therebetween; a gear mechanism connected to the rotor; a housing including a motor housing accommodating the motor therein and a gear housing located on one side in an axial direction of the motor housing and accommodating the gear mechanism therein; and a flow passage through which a fluid flows therein. The rotor has a hollow motor shaft extending in the axial direction. The gear mechanism includes a hollow gear shaft connected to one side in the axial direction of the motor shaft. The gear housing contains the fluid therein. The flow passage includes the first flow passage portion connecting the inside of the gear housing and the inside of the gear shaft, the second flow passage portion at least a part of which is configured by the inside of the gear shaft and the inside of the motor shaft and connected to the first flow passage portion, the third flow passage portion connected to the portion of the second flow passage portion on the other side in the axial direction, and the first fluid supply portion connected to the third flow passage portion and located on the vertically upper side of the stator.

One aspect of an exemplary drive apparatus of the present invention includes: a motor having a rotor rotatable about a center axis and a stator facing the rotor with a gap interposed therebetween; a gear mechanism connected to the rotor; a housing having a motor housing accommodating the motor therein and a gear housing located on one side in an axial direction of the motor housing and accommodating the gear mechanism therein; a hollow drive shaft connected to the gear mechanism and extending in the axial direction; and a flow passage through which a fluid flows therein. The gear housing contains the fluid therein. The flow passage includes a first flow passage portion connecting the inside of the gear housing and the inside of the drive shaft, a second flow passage portion at least a part of which is configured by the inside of the drive shaft and connected to the first flow passage portion, a third flow passage portion connected to a portion of the second flow passage portion on the other side in the axial direction, and a first fluid supply portion connected to the third flow passage portion and located on a vertically upper side of the stator.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view illustrating a drive apparatus according to a first embodiment;

FIG. 2 is a cross-sectional view schematically illustrating the drive apparatus of the first embodiment;

FIG. 3 is a cross-sectional view schematically illustrating the drive apparatus of the first embodiment, and is a view of the drive apparatus as viewed from one side in the axial direction;

FIG. 4 is a cross-sectional view illustrating a part of the drive apparatus of the first embodiment;

FIG. 5 is a cross-sectional view illustrating a part of a drive apparatus according to a second embodiment;

FIG. 6 is a cross-sectional view schematically illustrating a drive apparatus of a third embodiment;

FIG. 7 is a cross-sectional view schematically illustrating a drive apparatus according to a fourth embodiment; and

FIG. 8 is a cross-sectional view schematically illustrating a drive apparatus of a fifth embodiment.

### DETAILED DESCRIPTION

The following description will be made with a vertical direction being defined on the basis of positional relationships in the case where a drive apparatus according to embodiments is installed in a vehicle located on a horizontal road surface. That is, it is sufficient that the relative positional relationships regarding the vertical direction described in the following embodiments are satisfied at least in the case where the drive apparatus is installed in the vehicle located on the horizontal road surface.

In the drawings, an xyz coordinate system is illustrated appropriately as a three-dimensional orthogonal coordinate system. In the XYZ coordinate system, a Z-axis direction corresponds to the vertical direction. An arrow in the Z-axis is directed toward a side (+Z side) that is an upper side in the vertical direction, and a side (−Z side) opposite to the side toward which the arrow in the Z-axis is directed is a lower side in the vertical direction. In the following description, the upper side and the lower side in the vertical direction will be referred to simply as the “upper side” and the “lower side”, respectively. An X-axis direction is orthogonal to the Z-axis direction and corresponds to a front-rear direction of the vehicle on which the drive apparatus is mounted. In the following embodiments, a side (+X side) toward which an arrow in the X-axis is directed is a front side in the vehicle, and a side (−X side) opposite to the side toward which the arrow in the X-axis is directed is a rear side in the vehicle. A Y-axis direction is orthogonal to both the X-axis direction and the Z-axis direction and corresponds to a left-right direction of the vehicle, i.e., a vehicle lateral direction. In the following embodiments, a side (+Y side) toward which an arrow in the Y-axis is directed is a left side in the vehicle, and a side (−Y side) opposite to the side toward which the arrow in the Y-axis is directed is a right side in the vehicle. Each of the front-rear direction and the left-right direction is a horizontal direction perpendicular to the vertical direction.

A positional relationship in the front-rear direction is not limited to the positional relationship of the following embodiments. The side (+X side) toward which the arrow in the X-axis is directed may be the rear side in the vehicle, and the side (−X side) opposite to the side toward which the arrow in the X-axis is directed may be the front side in the vehicle. In this case, the side (+Y side) toward which the arrow in the Y-axis is directed is the right side in the vehicle, and the side (−Y side) opposite to the side toward which the arrow in the Y-axis is directed is the left side in the vehicle. In the present specification, a “parallel direction” includes a substantially parallel direction, and an “orthogonal direction” includes a substantially orthogonal direction.

A center axis J1 illustrated in the drawing as appropriate is an imaginary axis extending in a direction intersecting the vertical direction. More specifically, the center axis J1 extends in the Y-axis direction perpendicular to the vertical direction, that is, in the left-right direction of the vehicle. In description below, unless otherwise particularly stated, a direction parallel to the center axis J1 is simply referred to as the “axial direction”, a radial direction about the center axis J1 is simply referred to as the “radial direction”, and a circumferential direction about the center axis J1, that is, a direction around the center axis J1 is simply referred to as the “circumferential direction”. In the following embodiment, the left side (+Y side) is referred to as “one side in the axial direction”, and the right side (−Y side) is referred to as “other side in the axial direction”.

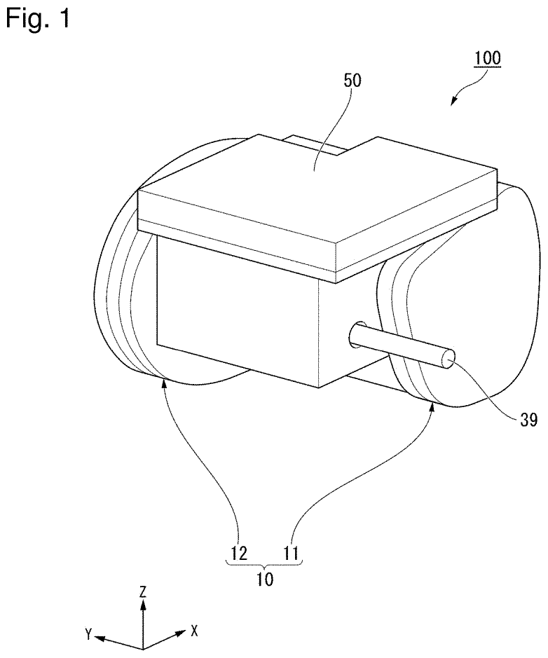

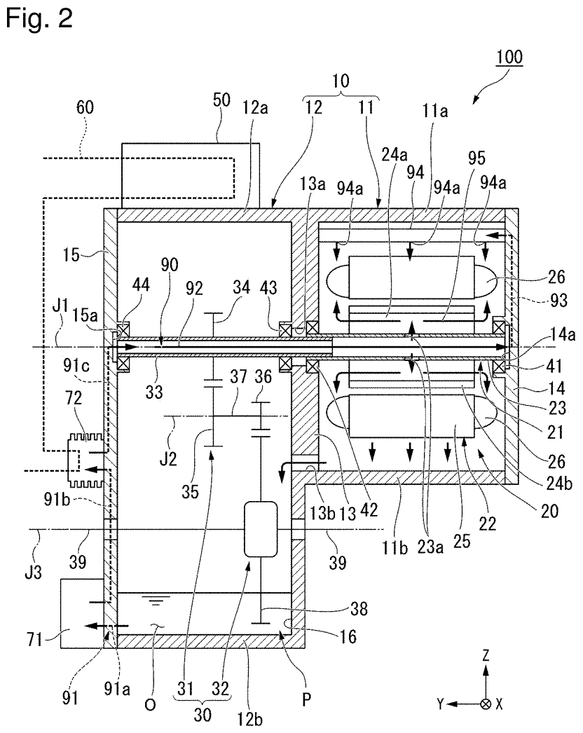

A drive apparatus 100 of the present embodiment illustrated in FIG. 1 is a drive apparatus that is mounted on a vehicle and rotates a drive shaft 39 connected to a wheel (not illustrated). The vehicle on which the drive apparatus 100 is mounted is a vehicle including a motor as a power source, such as a hybrid vehicle (HEV), a plug-in hybrid vehicle (PHV), or an electric vehicle (EV). As illustrated in FIG. 1, the drive apparatus 100 includes a housing 10 and an inverter unit 50. As illustrated in FIG. 2, the drive apparatus 100 includes a motor 20, a gear mechanism 30, a pump 71, and a cooler 72.

The housing 10 includes a motor housing 11 that accommodates the motor 20 therein, a gear housing 12 that accommodates the gear mechanism 30 therein, and a partition wall 13 that partitions the inside of the motor housing 11 and the inside of the gear housing 12. In the present embodiment, the gear housing 12 is connected to one side (+Y side) in the axial direction of the motor housing 11. That is, the gear housing 12 is located on one side in the axial direction of the motor housing 11. The partition wall 13 axially separates the inside of the motor housing 11 and the inside of the gear housing 12. The partition wall 13 has a hole 13a axially penetrating the partition wall 13. The partition wall 13 has a partition opening 13b that connects the inside of the motor housing 11 and the inside of the gear housing 12.

The motor housing 11 has a substantially cylindrical shape extending in the axial direction. The motor housing 11 includes a motor housing body 11a and a motor cover 14. In the present embodiment, the motor housing body 11a and the motor cover 14 are separated from each other. The motor housing body 11a and the motor cover 14 may be a part of the same single member.

The motor housing body 11a is a peripheral wall portion surrounding the motor 20 around the center axis J1. The motor cover 14 is a wall on the other side (−Y side) in the axial direction among walls constituting the motor housing 11. The motor cover 14 is located on the other side in the axial direction of the motor 20. In the present embodiment, the motor cover 14 is disposed with the internal space of the motor housing 11 interposed between the partition wall 13 and the motor cover. A surface on one side (+Y side) in the axial direction of the motor cover 14 is provided with a holding hole 14a recessed to the other side in the axial direction.

The gear housing 12 includes a gear housing body 12a and a gear cover 15. In the present embodiment, the gear housing body 12a and the gear cover 15 are separated from each other. Note that the gear housing body 12a and the gear cover 15 may be a part of the same single member.

The gear housing body 12a is a peripheral wall portion surrounding the gear mechanism 30 around the center axis J1. The gear cover 15 is a wall on one side (+Y side) in the axial direction among walls constituting the gear housing 12. The gear cover 15 is located on one side in the axial direction of the gear mechanism 30. In the present embodiment, the gear cover 15 is disposed with the internal space of the gear housing 12 interposed between the gear cover and the partition wall 13. A bottom portion 12b of the gear housing 12 located on the lower side is located below a bottom portion 11b of the motor housing 11 located on the lower side. The gear cover 15 has a holding hole 15a recessed from the surface on the other side (−Y side) in the axial direction of the gear cover 15 toward one side (+Y side) in the axial direction.

The gear housing 12 accommodates the oil O as a fluid. A first reservoir 16 capable of storing the oil O is provided in the inside of the gear housing 12. That is, the drive apparatus 100 includes the first reservoir 16. The first reservoir 16 is configured by a lower portion of the gear housing 12. The inside of the first reservoir 16 is a lower region in the inside of the gear housing 12. A part of the first reservoir 16 is configured by the bottom portion 12b of the gear housing 12. Since the oil O is stored in the first reservoir 16, an oil pool P is provided in a lower region in the inside of the gear housing 12.

The oil O flows in a flow passage 90 described later. In the present embodiment, the oil O is used as a refrigerant for cooling the motor 20. The oil O is used as lubricating oil for the gear mechanism 30 and each bearing described later. As the oil O, for example, an oil equivalent to an automatic transmission fluid (ATF) having a relatively low viscosity is preferably used to function as a refrigerant and a lubricating oil.

The motor 20 includes a rotor 21 rotatable about the center axis J1 and a stator 22 facing the rotor 21 with a gap interposed therebetween. The rotor 21 includes a hollow motor shaft 23 extending in the axial direction, a rotor core 24a fixed to an outer peripheral surface of the motor shaft 23, and a magnet 24b fixed to the rotor core 24a. The motor shaft 23 has a cylindrical shape opening on both sides in the axial direction with the center axis J1 as the center. The motor shaft 23 has a through hole 23a radially penetrating the wall of the motor shaft 23 from the inner peripheral surface of the motor shaft 23 to the outer peripheral surface of the motor shaft 23. A plurality of through holes 23a are provided at intervals in the circumferential direction. The inner peripheral surface of the motor shaft 23 provided with the through hole 23a is a part of the inner peripheral surface of the second flow passage portion 92 described later.

The end portion on the other side (−Y side) in the axial direction of the motor shaft 23 is supported by the motor cover 14 via a bearing 41. The end portion on one side (+Y side) in the axial direction of the motor shaft 23 is supported by the partition wall 13 via a bearing 42. The rotor 21 is rotatably supported around the center axis J1 by the bearings 41 and 42. That is, in the present embodiment, the drive apparatus 100 includes the bearings 41 and 42 that rotatably support the motor shaft 23. The bearing 41 is held in the holding hole 14a of the motor cover 14 and supports the end portion on the other side in the axial direction of the motor shaft 23. The bearing 42 is held in the hole 13a of the partition wall 13 and supports the end portion on one side in the axial direction of the motor shaft 23. The bearings 41 and 42 are, for example, ball bearings.

The stator 22 is located radially outside the rotor 21. The stator 22 is fixed to the inside of the motor housing 11. The stator 22 includes an annular stator core 25 surrounding the rotor 21 and a plurality of coils 26 attached to the stator core 25.

The gear mechanism 30 is connected to the rotor 21. More specifically, the gear mechanism 30 is connected to the end portion on one side (+Y side) in the axial direction of the motor shaft 23. The gear mechanism 30 includes a reduction gear 31 and a differential device 32. The reduction gear 31 is connected to the end portion on one side in the axial direction of the motor shaft 23. The reduction gear 31 includes a first gear shaft 33, a first gear 34, a second gear 35, a third gear 36, and a second gear shaft 37. That is, the gear mechanism 30 includes the first gear shaft 33, the first gear 34, the second gear 35, the third gear 36, and the second gear shaft 37.

The first gear shaft 33 is connected to one side (+Y side) in the axial direction of the motor shaft 23. The first gear shaft 33 is a hollow shaft extending in the axial direction. The first gear shaft 33 has a cylindrical shape that is centered on the center axis J1 and opens to both sides in the axial direction. The end portion on the other side (−Y side) in the axial direction of the first gear shaft 33 is fitted to the inside of the motor shaft 23. In the present embodiment, the end portion on the other side in the axial direction of the first gear shaft 33 is connected to the end portion on one side in the axial direction of the motor shaft 23 by spline fitting. That is, in the present embodiment, the motor shaft 23 and the first gear shaft 33 are separated from each other and are connected to each other by spline fitting. The first gear shaft 33 is rotatably supported about the center axis J1 by a bearing 43 held in the hole 13a of the partition wall 13 and a bearing 44 held in the holding hole 15a of the gear cover 15. The bearings 43 and 44 are, for example, ball bearings.

The first gear 34 is fixed to the outer peripheral surface of the first gear shaft 33. Thus, the first gear 34 is connected to the rotor 21 via the first gear shaft 33. The first gear shaft 33 and the first gear 34 rotate about the center axis J1 together with the rotor 21.

The second gear shaft 37 extends in the axial direction. The second gear shaft 37 has a columnar shape centered on the intermediate axis J2 extending in the axial direction. The intermediate axis J2 is an imaginary axis parallel to the center axis J1. The intermediate axis J2 is positioned, for example, below the center axis J1. In the present embodiment, the second gear shaft 37 is a shaft that is provided in the gear mechanism 30 and rotates together with the second gear 35.

The second gear 35 and the third gear 36 are fixed to the outer peripheral surface of the second gear shaft 37. The second gear 35 meshes with the first gear 34. The third gear 36 meshes with a ring gear 38 (to be described later) of the differential device 32. The rotation speed of the first gear shaft 33 and the rotation speed of the first gear 34 are the same as the rotation speed of the rotor 21. The rotation speed of the second gear 35, the rotation speed of the third gear 36, and the rotation speed of the second gear shaft 37 are smaller than the rotation speed of the rotor 21.

The differential device 32 has the ring gear 38. Torque output from the motor 20 is transmitted to the ring gear 38 via the reduction gear 31. The lower end portion of the ring gear 38 is located in the inside of the first reservoir 16. The lower end portion of the ring gear 38 is a lower end portion of the gear mechanism 30. That is, in the present embodiment, the lower end portion of the gear mechanism 30 is located in the first reservoir 16. As a result, the lower end portion of the ring gear 38 is immersed in the oil pool P provided in the first reservoir 16. When the ring gear 38 rotates, the oil O in the oil pool P is scraped up. The scraped oil O is supplied to, for example, the reduction gear 31 and the differential device 32 as lubricating oil. The differential device 32 rotates the drive shaft 39 about the differential axis J3. The differential axis J3 is an imaginary axis extending in parallel with the center axis J1.

In the present embodiment, the drive apparatus 100 includes the flow passage 90 through which the oil O flows. In the present embodiment, the flow passage 90 is an oil passage through which the oil O flows. The flow passage 90 includes a first flow passage portion 91, a second flow passage portion 92, a third flow passage portion 93, a first fluid supply portion 94, and an intra-rotor core flow passage portion 95.

The first flow passage portion 91 is a flow passage portion connecting the inside of the gear housing 12 and the inside of the first gear shaft 33. In the present embodiment, the first flow passage portion 91 is provided in the gear cover 15. The first flow passage portion 91 includes a first connection flow passage portion 91a connecting the inside of the first reservoir 16 and the pump 71, a second connection flow passage portion 91b connecting the pump 71 and the cooler 72, and a third connection flow passage portion 91c connecting the cooler 72 and the inside of the first gear shaft 33.

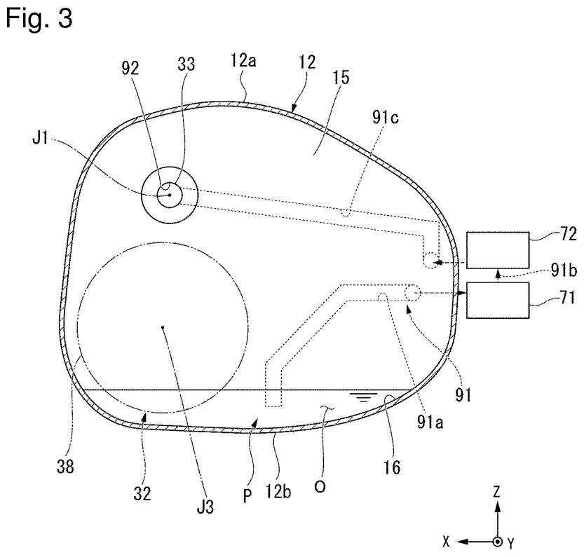

As illustrated in FIG. 3, one end portion of the first connection flow passage portion 91a is connected to the inside of the first reservoir 16. The other end portion of the first connection flow passage portion 91a is located above and behind (−X side) one end portion of first connection flow passage portion 91a, and is connected to the pump 71. The third connection flow passage portion 91c extends forward (+X side) and obliquely upward from the cooler 72 and is connected to the inside of the first gear shaft 33.

As illustrated in FIG. 2, the second flow passage portion 92 is a flow passage portion at least a part of which is configured by the inside of the first gear shaft 33 and the inside of the motor shaft 23. In the present embodiment, the entire second flow passage portion 92 is configured by the inside of the first gear shaft 33 and the inside of the motor shaft 23. The second flow passage portion 92 extends in the axial direction. The second flow passage portion 92 is connected to the first flow passage portion 91. More specifically, the end portion on one side (+Y side) in the axial direction of the second flow passage portion 92 is connected to the upper end portion of the third connection flow passage portion 91c via the holding hole 15a provided in the gear cover 15.

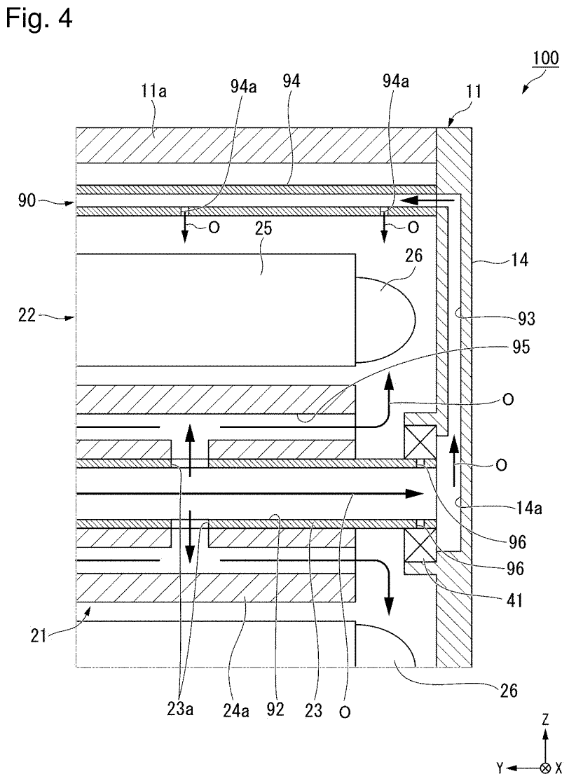

The third flow passage portion 93 is a flow passage portion connected to a portion of the second flow passage portion 92 on the other side (−Y side) in the axial direction. In the present embodiment, the third flow passage portion 93 is connected to the end portion on the other side in the axial direction of the second flow passage portion 92 via the holding hole 14a provided in the motor cover 14. In the present embodiment, the third flow passage portion 93 is provided in the motor cover 14. The third flow passage portion 93 extends in the vertical direction. The third flow passage portion 93 extends upward from the end portion on the other side in the axial direction of the second flow passage portion 92. As illustrated in FIG. 4, the flow passage cross-sectional area of the third flow passage portion 93 is smaller than the flow passage cross-sectional area of the second flow passage portion 92. That is, in the present embodiment, the flow passage cross-sectional area of the second flow passage portion 92 is larger than the flow passage cross-sectional area of the third flow passage portion 93.

As illustrated in FIG. 2, the first fluid supply portion 94 is located in the inside of the motor housing 11. The first fluid supply portion 94 is located on the vertically upper side of the stator 22. In the present embodiment, the first fluid supply portion 94 is a pipe member extending in the axial direction. The first fluid supply portion 94 is, for example, a cylindrical pipe opened on both sides in the axial direction. The end portion on one side (+Y side) in the axial direction of the first fluid supply portion 94 is held by the partition wall 13. The end portion on the other side (−Y side) in the axial direction of the first fluid supply portion 94 is held by the motor cover 14. The first fluid supply portion 94 is connected to the third flow passage portion 93. More specifically, the end portion on the other side in the axial direction of the first fluid supply portion 94 is connected to the upper end portion of the third flow passage portion 93. As illustrated in FIG. 4, the flow passage cross-sectional area of the first fluid supply portion 94 is, for example, the same as the flow passage cross-sectional area of the third flow passage portion 93.

The first fluid supply portion 94 has a plurality of supply ports 94a. The supply port 94a opens downward. In the present embodiment, each supply port 94a is configured by a hole provided in a portion located on the lower side of the wall of the pipe member constituting the first fluid supply portion 94. The oil O in the first fluid supply portion 94 is discharged from the plurality of supply ports 94a and supplied to the stator 22 from above. As a result, the first fluid supply portion 94 supplies the oil O to the stator 22.

The intra-rotor core flow passage portion 95 is provided in the rotor core 24a. The intra-rotor core flow passage portion 95 is connected to the second flow passage portion 92 via the through hole 23a. The intra-rotor core flow passage portion 95 opens at both axial end portions of the rotor core 24a.

The flow passage 90 includes a second fluid supply portion 96 that supplies the oil O to the bearing 41 that rotatably supports the motor shaft 23. In the present embodiment, the second fluid supply portion 96 is configured by a hole radially penetrating the wall of the motor shaft 23 from the inner peripheral surface of the motor shaft 23 to the outer peripheral surface of the motor shaft 23. A plurality of the second fluid supply portions 96 are provided at intervals in the circumferential direction. The second fluid supply portion 96 is provided in a portion of the motor shaft 23 held by the bearing 41. The second fluid supply portion 96 is connected to the second flow passage portion 92. The second fluid supply portion 96 opens into the holding hole 14a.

In the present specification, “certain two flow passage parts are connected” means that a fluid may flow from one of the two flow channel parts to the other flow channel part.

As illustrated in FIG. 2, the pump 71 and the cooler 72 are attached to the gear cover 15 of the gear housing 12. In the present embodiment, the pump 71 is an electric pump that sends the oil O. The cooler 72 is provided in the first flow passage portion 91. More specifically, the cooler 72 is provided between the second connection flow passage portion 91b and the third connection flow passage portion 91c. A part of a refrigerant circulation path 60 passes through the cooler 72. The refrigerant circulation path 60 is a flow passage through which the refrigerant circulates. The refrigerant flowing in the refrigerant circulation path 60 is, for example, water. The refrigerant circulation path 60 passes through the inverter unit 50 and the cooler 72 in this order from a radiator (not illustrated) and returns to the radiator. The cooler 72 cools the oil O flowing through the first flow passage portion 91 by heat exchange with the refrigerant flowing through the refrigerant circulation path 60.

When the pump 71 is driven, the oil O in the oil pool P is sucked into the flow passage 90 from the lower end portion of the first flow passage portion 91. The oil O sucked into the flow passage 90 flows through the first connection flow passage portion 91a, the pump 71, the second connection flow passage portion 91b, the cooler 72, and the third connection flow passage portion 91c in this order, and flows into the end portion on one side (+Y side) in the axial direction of the second flow passage portion 92. The oil O flowing into the second flow passage portion 92 flows in the other axial direction (−Y direction) in the second flow passage portion 92, and flows from the gear housing 12 into the motor housing 11.

Part of the oil O flowing into the second flow passage portion 92 is supplied to a portion where the motor shaft 23 and the first gear shaft 33 are spline-fitted. The other part of the oil O flowing into the second flow passage portion 92 flows into the intra-rotor core flow passage portion 95 via the through hole 23a. The oil O flowing into the intra-rotor core flow passage portion 95 scatters radially outward from both axial end portions of the rotor core 24a and is supplied to the coil 26. Accordingly, the rotor 21 and the stator 22 can be cooled by the oil O. Still another part of the oil O flowing into the second flow passage portion 92 is supplied from the second fluid supply portion 96 to the bearing 41. As a result, the oil O can be supplied to the bearing 41 as lubricating oil. The remaining part of the oil O flowing into the second flow passage portion 92 flows into the third flow passage portion 93. The oil O flowing into the third flow passage portion 93 flows into the first fluid supply portion 94.

The oil O flowing into the first fluid supply portion 94 is discharged from the plurality of supply ports 94a to the inside of the motor housing 11. The oil O discharged from the plurality of supply ports 94a is supplied to the stator 22. Accordingly, the stator 22 can be further cooled by the oil O. The oil O supplied from the intra-rotor core flow passage portion 95 to the stator 22, the oil O supplied from the second fluid supply portion 96 to the bearing 41, and the oil O supplied from the supply port 94a to the stator 22 fall downward and accumulate in the lower region in the motor housing 11. The oil O accumulated in the lower region in the motor housing 11 returns into the gear housing 12 via the partition opening 13b provided in the partition wall 13.

According to the present embodiment, the flow passage 90 includes the first flow passage portion 91 connecting the inside of the gear housing 12 and the inside of the first gear shaft 33, the second flow passage portion 92 at least a part of which is configured by the inside of the first gear shaft 33 and the inside of the motor shaft 23 and connected to the first flow passage portion 91, the third flow passage portion 93 connected to the portion of the second flow passage portion 92 on the other side in the axial direction, and the first fluid supply portion 94 connected to the third flow passage portion 93 and located on the vertically upper side of the stator 22. That is, the first flow passage portion 91, the second flow passage portion 92, the third flow passage portion 93, and the first fluid supply portion 94 are integrally connected. Therefore, the oil O can be sequentially supplied to each flow passage portion including the inside of the motor shaft 23, the first fluid supply portion 94 located above the stator 22, and the like by one pump 71. As a result, the oil O can be efficiently supplied to each portion of the drive apparatus 100 as compared with the case of using the plurality of pumps 71.

For example, as compared with a case where the oil O after being supplied from the first fluid supply portion 94 to the stator 22 flows into the second flow passage portion 92, it is possible to easily flow the oil O into the second flow passage portion 92 configured by each shaft via the first flow passage portion 91 or the third flow passage portion 93. The temperature of the oil O supplied to the stator 22 varies depending on the amount of heat generated by the stator 22 and the like. Therefore, the viscosity of the oil O after being supplied to the stator 22 varies depending on the amount of heat generated by the stator 22 and the like. As a result, when the oil O after being supplied to the stator 22 flows to the second flow passage portion 92, the flow rate of the oil O flowing to the second flow passage portion 92 varies due to the viscosity of the oil O after being supplied to the stator 22. On the other hand, in the present embodiment, since the oil O before being supplied to the stator 22 is supplied to the second flow passage portion 92, the flow rate of the oil O supplied to the second flow passage portion 92 can be stabilized.

For example, in a case where the oil O flows by branching into the second flow passage portion 92 and the first fluid supply portion 94, there is a possibility that a ratio between a flow rate of the oil O supplied to the second flow passage portion 92 and a flow rate of the oil O supplied to the first fluid supply portion 94 changes due to a change in viscosity of the oil O. Specifically, for example, the flow rate of the oil O supplied from the first fluid supply portion 94 to the stator 22 via the supply port 94a is likely to change due to the viscosity of the oil O. Therefore, when the oil O flows by branching into the second flow passage portion 92 and the first fluid supply portion 94, the viscosity of the oil O changes, so that the flow rate of the oil O flowing to the first fluid supply portion 94 changes, and the flow rate of the oil O flowing to the second flow passage portion 92 may vary. On the other hand, according to the present embodiment, since the second flow passage portion 92 and the first fluid supply portion 94 are connected to each other by the third flow passage portion 93, it is possible to suppress the variation in the flow rate of the oil O supplied to the second flow passage portion 92 even when the viscosity of the oil O changes.

As described above, in the drive apparatus 100, the efficiency of supplying the oil O to each portion can be improved. The flow rate of the oil O supplied to each portion of the drive apparatus 100 can be easily and suitably controlled. Since it is not necessary to provide the plurality of pumps 71, the number of components of the drive apparatus 100 can be reduced. It is possible to suppress complication of the flow passage 90 as compared with a case where a branched flow passage portion is provided. Therefore, it is possible to reduce the number of man-hours required for the work of making the flow passage 90. Thus, the manufacturing cost of the drive apparatus 100 can be reduced.

According to the present embodiment, the pump 71 causes the oil O to flow into the flow passage 90 in a direction in which the oil O flows from the second flow passage portion 92 to the first fluid supply portion 94 via the third flow passage portion 93. Therefore, the oil O sent by the pump 71 flows through the second flow passage portion 92 before the first fluid supply portion 94. Accordingly, when the cooler 72 is provided near the pump 71 as in the present embodiment, the relatively low-temperature oil O cooled by the cooler 72 can easily flow into the second flow passage portion 92. Therefore, the relatively low-temperature oil O can be easily flown into the motor shaft 23, and the rotor 21 can be easily cooled. Therefore, it is easy to cool the magnet 24b of the rotor 21, and it is possible to suppress the temperature of the magnet 24b from becoming high. Accordingly, demagnetization of the magnet 24b can be suppressed. Therefore, it is possible to suppress a decrease in the output torque of the motor 20. As a result, even if an inexpensive magnet having a relatively small magnetic force is used as the magnet 24b, the output torque of the motor 20 can be maintained. Therefore, the manufacturing cost of the drive apparatus 100 can be reduced using the inexpensive magnet 24b while maintaining the output of the drive apparatus 100. In the present embodiment, since the intra-rotor core flow passage portion 95 connected to the second flow passage portion 92 is provided, the relatively low-temperature oil O can be caused to flow from the second flow passage portion 92 to the intra-rotor core flow passage portion 95, and the magnet 24b fixed to the rotor core 24a can be more suitably cooled.

According to the present embodiment, the motor shaft 23 has the through hole 23a that radially penetrates the wall of the motor shaft 23 from the inner peripheral surface of the second flow passage portion 92 to the outer peripheral surface of the motor shaft 23. Therefore, part of the oil O flowing through the second flow passage portion 92 can be supplied to the radial outside of the motor shaft 23 through the through hole 23a. As a result, the rotor core 24a and the magnet 24b fixed to the motor shaft 23 can be more easily cooled by the oil O.

According to the present embodiment, the flow passage cross-sectional area of the second flow passage portion 92 is larger than the flow passage cross-sectional area of the third flow passage portion 93. Therefore, the flow rate of the oil O flowing in the second flow passage portion 92 can be increased. As a result, the flow rate of the oil O flowing from the inside of the second flow passage portion 92 to the radial outside of the motor shaft 23 through the through hole 23a can be increased. Therefore, the rotor core 24a and the magnet 24b can be more easily cooled by the oil O.

According to the present embodiment, the motor shaft 23 and the first gear shaft 33 are separated from each other and connected to each other by spline fitting. Therefore, part of the oil O flowing through the second flow passage portion 92 can be supplied to the spline fitting portion between the motor shaft 23 and the first gear shaft 33. As a result, it is easy to maintain a state in which the motor shaft 23 and the first gear shaft 33 are suitably connected. The oil O supplied to the spline fitting portion between the motor shaft 23 and the first gear shaft 33 can also be supplied to the bearing supporting each shaft. Specifically, in the present embodiment, the oil O supplied to the spline fitting portion between the motor shaft 23 and the first gear shaft 33 flows into the hole 13a and is supplied to the bearings 42 and 43 held in the hole 13a.

According to the present embodiment, the flow passage 90 includes the second fluid supply portion 96 that supplies the oil O to the bearing 41. Therefore, the oil O can be suitably supplied to the bearing 41 as a lubricant. The flow passage 90 may have a second fluid supply portion that supplies the oil O to the other bearings 42, 43, and 44, or may have a second fluid supply portion that supplies the oil O to the bearing that supports the second gear shaft 37.

According to the present embodiment, the first fluid supply portion 94 is a pipe member extending in the axial direction. Therefore, the first fluid supply portion 94 can be easily formed. It is easy to pump the oil O into the first fluid supply portion 94. Therefore, the oil O can be suitably easily fed to the first fluid supply portion 94.

According to the present embodiment, the cooler 72 is provided in the first flow passage portion 91. Therefore, the oil O flowing through the first flow passage portion 91 can be cooled by the cooler 72. Accordingly, when the oil O flows in the direction from the first flow passage portion 91 toward the second flow passage portion 92 as in the present embodiment, the oil O that has just been cooled by the cooler 72 in the first flow passage portion 91 can flow to the second flow passage portion 92. Therefore, the temperature of the oil O flowing in the motor shaft 23 can be suitably lowered. Accordingly, the rotor 21 can be more suitably cooled. Therefore, the magnet 24b can be more suitably cooled.

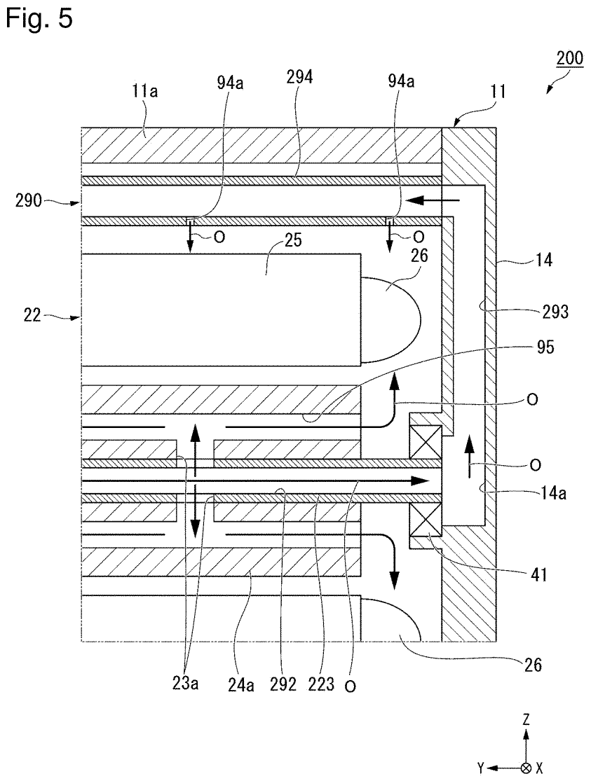

Hereinafter, configurations similar to those of the above-described embodiment are denoted by the same reference numerals as appropriate, and the description thereof may be omitted. As illustrated in FIG. 5, in the drive apparatus 200 of the present embodiment, the inner diameter of a hollow motor shaft 223 is smaller than the inner diameter of the motor shaft 23 of the first embodiment. The flow passage cross-sectional area of a second flow passage portion 292 in the flow passage 290 is smaller than the flow passage cross-sectional area of the second flow passage portion 92 of the first embodiment. The flow passage cross-sectional area of a third flow passage portion 293 is larger than the flow passage cross-sectional area of the third flow passage portion 93 of the first embodiment. The flow passage cross-sectional area of a first fluid supply portion 294 is larger than the flow passage cross-sectional area of the first fluid supply portion 94 of the first embodiment.

The flow passage cross-sectional area of the second flow passage portion 292 is smaller than the flow passage cross-sectional area of the third flow passage portion 293. Therefore, the flow rate of the oil O flowing through the second flow passage portion 292 can be easily reduced, and the flow rate of the oil O flowing from the second flow passage portion 292 to the intra-rotor core flow passage portion 95 through the through hole 23a can be reduced. As a result, the flow rate of the oil O flowing from the third flow passage portion 293 to the first fluid supply portion 294 can be relatively increased. Therefore, the flow rate of the oil O supplied from the first fluid supply portion 294 to the stator 22 can be increased. Other configurations of the drive apparatus 200 are similar to the other configurations of the drive apparatus 100 of the first embodiment.

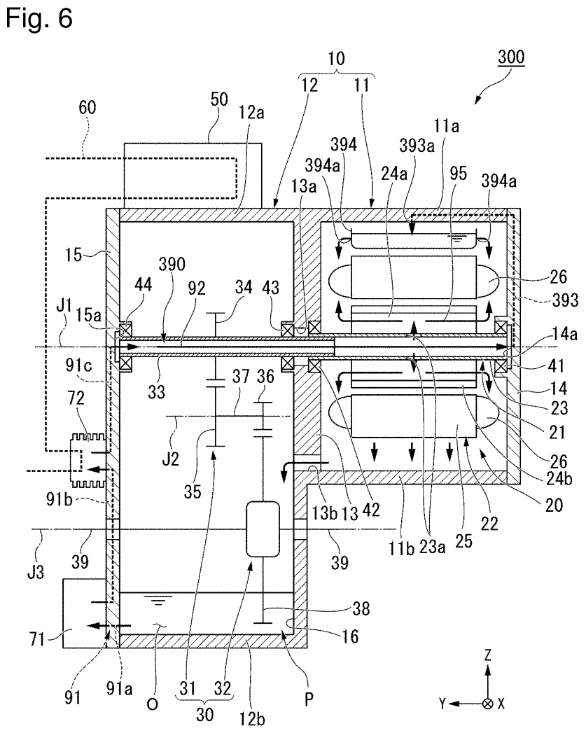

Hereinafter, configurations similar to those of the above-described embodiment are denoted by the same reference numerals as appropriate, and the description thereof may be omitted. As illustrated in FIG. 6, in the flow passage 390 of the drive apparatus 300 of the present embodiment, a first fluid supply portion 394 is a gutter member that opens vertically upward. Therefore, even in a case where it is difficult to supply the oil O from the pipe member to the stator 22, such as a case where the oil O is highly viscous and it is difficult to pressure-feed the oil O, it is easy to suitably supply the oil O from a supply port 394a of the first fluid supply portion 394 to the stator 22.

The end portion of a third flow passage portion 393 on the side opposite to the side connected to the second flow passage portion 92 is an opening portion 393a opened in the motor housing 11. The opening portion 393a is provided in a wall positioned on an upper side of walls constituting the motor housing 11. The opening portion 393a is located above the first fluid supply portion 394. The opening portion 393a opens downward. The oil O in the third flow passage portion 393 discharged from the opening portion 393a is supplied into the first fluid supply portion 394 from above. The oil O is stored in the first fluid supply portion 394. The oil O stored in the first fluid supply portion 394 flows along the gutter shaped first fluid supply portion 394 and is supplied from the supply port 394a to the stator 22. Other configurations of the drive apparatus 300 are similar to the other configurations of the drive apparatus 100 of the first embodiment.

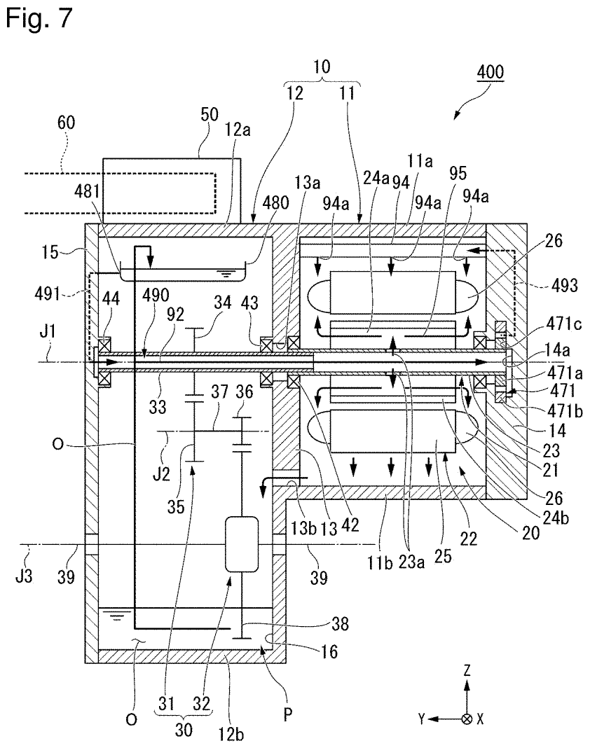

Hereinafter, configurations similar to those of the above-described embodiment are denoted by the same reference numerals as appropriate, and the description thereof may be omitted. As illustrated in FIG. 7, a drive apparatus 400 of the present embodiment includes a second reservoir 480 provided in the gear housing 12. The second reservoir 480 is located above the first reservoir 16. In the present embodiment, the second reservoir 480 is located above the gear mechanism 30. The second reservoir 480 opens upward. The second reservoir 480 has, for example, a gutter shape. At least part of the oil O scraped up by the ring gear 38 is stored in the inside of the second reservoir 480. The second reservoir 480 has a supply port 481.

The second reservoir 480 is provided in a flow passage 490. A first flow passage portion 491 of the flow passage 490 is connected to the supply port 481 of the second reservoir 480. In the present embodiment, the first flow passage portion 491 connects the second reservoir 480 and the second flow passage portion 92.

In the present embodiment, a pump 471 is a mechanical pump. The pump 471 is connected to the end portion on the other side (−Y side) in the axial direction of the motor shaft 23. The pump 471 includes an annular inner rotor 471a fixed to the outer peripheral surface of the motor shaft 23 and an annular outer rotor 471b surrounding the inner rotor 471a on the radially outer side. The inner rotor 471a and the outer rotor 471b are provided in a pump chamber 471c provided in the motor cover 14. The inner rotor 471a and the outer rotor 471b mesh with each other via tooth portions (not illustrated).

When the motor shaft 23 rotates and the inner rotor 471a rotates about the center axis J1, the outer rotor 471b also rotates. As a result, the oil O in the second reservoir 480 is sucked into the first flow passage portion 491. The oil O sucked into the first flow passage portion 491 flows through the first flow passage portion 491 and the second flow passage portion 92 in this order, and flows into the gap between the inner rotor 471a and the outer rotor 471b via the holding hole 14a. The oil O flowing into the gap between the inner rotor 471a and the outer rotor 471b moves in the circumferential direction as the inner rotor 471a and the outer rotor 471b rotate, and is discharged into a third flow passage portion 493. That is, in the present embodiment, the third flow passage portion 493 is connected to the second flow passage portion 92 via the pump 471. Other configurations of the drive apparatus 400 are similar to the other configurations of the drive apparatus 100 of the first embodiment.

According to the present embodiment, the drive apparatus 400 includes the second reservoir 480 that is provided in the inside of the gear housing 12 and can store the oil O. The second reservoir 480 is positioned vertically above the first reservoir 16 and is provided in the flow passage 490. Therefore, part of the oil O stored in the gear housing 12 can be stored in the second reservoir 480, and the amount of the oil O stored in the first reservoir 16 can be relatively reduced. As a result, the liquid level of the oil pool P in the first reservoir 16 can be lowered. Therefore, even if the height difference between the bottom portion 11b of the motor housing 11 and the bottom portion 12b of the gear housing 12 is small, the oil O supplied into the motor housing 11 by the flow passage 490 can be easily returned into the gear housing 12.

According to the present embodiment, the first flow passage portion 491 connects the second reservoir 480 and the second flow passage portion 92. The second reservoir 480 opens upward in the vertical direction. The lower end portion of the gear mechanism 30 in the vertical direction is located in the first reservoir 16. Therefore, part of the oil O in the first reservoir 16 scraped up by the gear mechanism 30 can be stored in the second reservoir 480. The oil O stored in the second reservoir 480 can flow to the second flow passage portion 92 via the first flow passage portion 491. As a result, the oil O can be suitably sent into the motor housing 11 via the second flow passage portion 92 while the liquid level of the oil pool P in the first reservoir 16 is lowered to easily return the oil O into the gear housing 12.

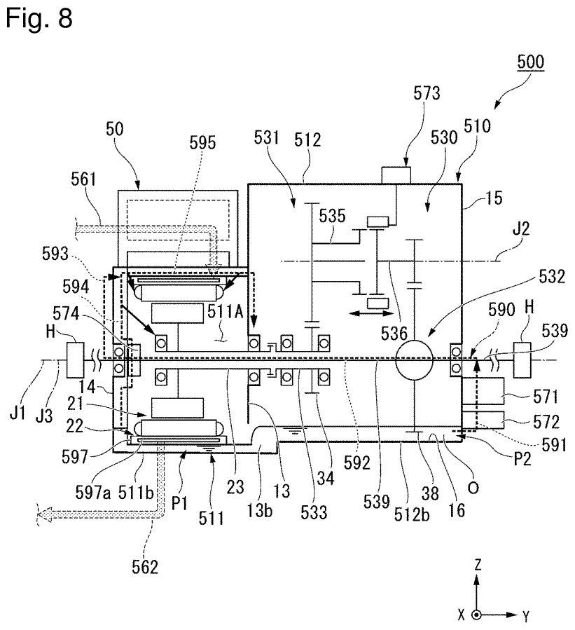

Hereinafter, configurations similar to those of the above-described embodiment are denoted by the same reference numerals as appropriate, and the description thereof may be omitted. As illustrated in FIG. 8, in a housing 510 of a drive apparatus 500, a bottom portion 511b of a motor housing 511 is positioned below a bottom portion 512b of a gear housing 512. In the motor housing 511, an oil pool P1 is provided below a flow passage member 597 described later. An oil pool P2 is provided in a lower region of the gear housing 512. The oil pool P1 and the oil pool P2 are connected to each other via the partition opening 13b of the partition wall 13. A part of the motor 20 may be immersed in the oil O of the oil pool P1.

A first gear shaft 533 of a reduction gear 531 in a gear mechanism 530 is a hollow shaft opening on both sides in the axial direction. A second gear 535 and a third gear 536 are switched between a connected state and a disconnected state by a clutch mechanism 573. The second gear 535 meshes with the first gear 34 connected to the rotor 21. The second gear 535 is rotatable about the intermediate axis J2 having different radial positions with respect to the center axis J1. In the present embodiment, the intermediate axis J2 is positioned above the center axis J1. The third gear 536 is rotatable about the intermediate axis J2 together with the second gear 535 in a state of being connected to the second gear 535 via the clutch mechanism 573.

The drive apparatus 500 includes a drive shaft 539 connected to the gear mechanism 530. The drive shaft 539 is a hollow shaft extending in the axial direction. The drive shafts 539 are provided on both sides in the axial direction of a differential device 532. Each drive shaft 539 is connected to a wheel H of the vehicle. The drive shaft 539 extending from the differential device 532 to the other side (−Y side) in the axial direction passes through the inside of the first gear shaft 533 and the inside of the motor shaft 23. In the present embodiment, the differential axis J3 of the differential device 532 coincides with the center axis J1 of the motor 20. In the present embodiment, the ring gear 38 of the differential device 532 corresponds to a fourth gear meshing with the third gear 536.

The drive apparatus 500 includes the flow passage member 597 disposed in the motor housing 511. The flow passage member 597 is disposed radially outside the stator 22. The flow passage member 597 has a tubular shape surrounding the stator 22. The flow passage member 597 is fixed to the inner peripheral surface of the motor housing 11. The flow passage member 597 is provided with a refrigerant flow passage 597a through which the refrigerant flows. The refrigerant flowing through the refrigerant flow passage 597a is, for example, water. That is, the flow passage member 597 is, for example, a water jacket. A refrigerant inflow passage 561 and a refrigerant outflow passage 562 extending from a radiator (not illustrated) are connected to the refrigerant flow passage 597a. The refrigerant cooled by a radiator (not illustrated) flows into the refrigerant flow passage 597a from the refrigerant inflow passage 561. The stator 22 can be cooled by the refrigerant flowing in the refrigerant flow passage 597a. The refrigerant in the refrigerant flow passage 597a flows out to the refrigerant outflow passage 562 and returns to a radiator (not illustrated).

In the present embodiment, a flow passage 590 through which the oil O flows includes a first flow passage portion 591, a second flow passage portion 592, a third flow passage portion 593, a fourth flow passage portion 594, and a first fluid supply portion 595. The first flow passage portion 591 is a flow passage portion connecting the inside of the gear housing 12 and the inside of the drive shaft 539. In the present embodiment, the first flow passage portion 591 connects the inside of the first reservoir 16 in which the oil pool P2 is provided and the inside of the drive shaft 539 extending from the differential device 532 to one side (+Y side) in the axial direction. The first flow passage portion 591 opens into the oil pool P2. A pump 571 and a cooler 572 are provided in the middle of the first flow passage portion 591. The pump 571 is an electric pump. In the present embodiment, the pump 571 and the cooler 572 are attached to the gear housing 512. More specifically, the pump 571 and the cooler 572 are attached to a wall of the gear housing 512 located on one side in the axial direction, that is, the gear cover 15.

The second flow passage portion 592 is a flow passage portion at least a part of which is configured by the inside of the drive shaft 539. In the present embodiment, the second flow passage portion 592 is configured by the inside of the drive shaft 539 on one side (+Y side) in the axial direction, the inside of the differential device 532, and the inside of the drive shaft 539 on the other side (−Y side) in the axial direction. The end portion on one side in the axial direction of the second flow passage portion 592 is connected to the first flow passage portion 591.

The third flow passage portion 593 is a flow passage portion connected to a portion of the second flow passage portion 592 on the other side (−Y side) in the axial direction. In the present embodiment, the third flow passage portion 593 connects the end portion on the other side in the axial direction of the second flow passage portion 592 and the end portion on the other side in the axial direction of the first fluid supply portion 595. In the present embodiment, the third flow passage portion 593 is provided in the motor housing 511. More specifically, the third flow passage portion 593 is provided in the motor cover 14. In the present embodiment, the motor cover 14 corresponds to an axial wall located on the other side in the axial direction of the stator 22.

The fourth flow passage portion 594 is a flow passage portion connecting the inside of the motor housing 511 and the first fluid supply portion 595. The fourth flow passage portion 594 opens into the oil pool P1. In the present embodiment, the fourth flow passage portion 594 is provided in the motor cover 14. Part of the oil O flowing in the fourth flow passage portion 594 is supplied to a bearing that rotatably supports the motor shaft 23. A mechanical pump 574 is provided in the fourth flow passage portion 594. The mechanical pump 574 is connected to the drive shaft 539 on the other side (−Y side) in the axial direction.

The first fluid supply portion 595 is located above the stator 22. In the present embodiment, the first fluid supply portion 595 is provided on an upper wall of the motor housing 511. The first fluid supply portion 595 extends in the axial direction. The first fluid supply portion 595 is connected to the third flow passage portion 593 and the fourth flow passage portion 594. More specifically, the upper end portion of the third flow passage portion 593 and the upper end portion of the fourth flow passage portion 594 are connected to the end portion on the other side (−Y side) in the axial direction of the first fluid supply portion 595. The first fluid supply portion 595 has a supply port for supplying the oil O to the stator 22 and the bearing supporting the motor shaft 23.

When the drive shaft 539 is driven, the mechanical pump 574 is driven. When the mechanical pump 574 is driven, the oil O in the oil pool P1 in the motor housing 511 is sucked into the fourth flow passage portion 594. The oil O sucked into the fourth flow passage portion 594 flows upward in the fourth flow passage portion 594 and flows into the first fluid supply portion 595. The oil O flowing into the first fluid supply portion 595 is supplied to the stator 22 and the bearing supporting the motor shaft 23.

When the pump 571 is driven, the oil O in the first reservoir 16, that is, the oil O in the oil pool P2 flows into the first flow passage portion 591. The oil O flowing into the first flow passage portion 591 flows through the cooler 572 and the pump 571 in this order, and flows into the end portion on one side (+Y side) in the axial direction of the second flow passage portion 592. The oil O flowing into the second flow passage portion 592 flows to the other side (−Y side) in the axial direction, passes through the third flow passage portion 593, and flows into the first fluid supply portion 595. The oil O flowing into the first fluid supply portion 595 is supplied to the stator 22 and the bearing supporting the motor shaft 23. Other configurations of the drive apparatus 500 can be made similarly to other configurations of the drive apparatus 100 of the first embodiment.

According to the present embodiment, the flow passage 590 is configured by the first flow passage portion 591 connecting the inside of the gear housing 512 and the inside of the drive shaft 539, the second flow passage portion 592 at least a part of which is configured by the inside of the drive shaft 539 and connected to the first flow passage portion 591, the third flow passage portion 593 connected to the portion of the second flow passage portion 592 on the other side in the axial direction, and the first fluid supply portion 595 connected to the third flow passage portion 593 and located on the vertically upper side of the stator 22. That is, the first flow passage portion 591, the second flow passage portion 592, the third flow passage portion 593, and the first fluid supply portion 595 are integrally connected. Therefore, similarly to the above-described embodiment, the oil O can be sequentially supplied to each flow passage portion including the inside of the drive shaft 539 and the like by one pump 571. As a result, the oil O can be efficiently supplied to each portion of the drive apparatus 500.

According to the present embodiment, the drive shaft 539 is inserted into the inside of the hollow motor shaft 23. Therefore, the second flow passage portion 592 at least a part of which is configured by the inside of the drive shaft 539 can be suitably arranged in the housing 510. Accordingly, the oil O in the gear housing 512 can be suitably and easily fed to the first fluid supply portion 595 via the second flow passage portion 592. It is easy to downsize the drive apparatus 500 as compared with a case where the drive shaft 539 is not inserted into the inside of the motor shaft 23.

According to the present embodiment, the gear mechanism 530 includes the first gear 34 connected to the rotor 21, the second gear 535 that is rotatable about the intermediate axis J2 having a different radial position with respect to the center axis J1 and meshes with the first gear 34, the third gear 536 that is rotatable about the intermediate axis J2 together with the second gear 535, and the differential device 532 that includes the ring gear 38 as the fourth gear meshing with the third gear 536 and rotates the drive shaft 539 about the differential axis J3. The differential axis J3 coincides with the center axis J1. Therefore, the drive shaft 539 can easily and suitably pass through the inside of the hollow motor shaft 23.

According to the present embodiment, the pump 571 and the cooler 572 are attached to the gear housing 512. Therefore, the oil O in the gear housing 512 can be easily sent to the inside of the drive shaft 539 by the pump 571. The cooler 572 easily cools the oil O sent from the inside of the gear housing 512 to the inside of the drive shaft 539.

According to the present embodiment, the third flow passage portion 593 is provided in the motor housing 511. Therefore, the third flow passage portion 593 can be formed without providing another member such as a pipe member. As a result, it is possible to suppress an increase in the number of components of the drive apparatus 500.

According to the present embodiment, the third flow passage portion 593 is provided in the motor cover 14 as an axial wall located on the other side (−Y side) in the axial direction of the stator 22. Therefore, the inside of the drive shaft 539 penetrating the motor cover 14 in the axial direction is easily connected to the third flow passage portion 593. Thus, the second flow passage portion 592 is easily connected to the third flow passage portion 593.

According to the present embodiment, the third flow passage portion 593 connects the end portion on the other side (−Y side) in the axial direction of the second flow passage portion 592 and the end portion on the other side in the axial direction of the first fluid supply portion 595. Therefore, the second flow passage portion 592 and the first fluid supply portion 595 are easily connected by the third flow passage portion 593.

According to the present embodiment, the flow passage 590 includes the fourth flow passage portion 594 connecting the inside of the motor housing 511 and the first fluid supply portion 595. Therefore, the oil O in the motor housing 511 can be sent to the first fluid supply portion 595 via the fourth flow passage portion 594. As a result, the oil O can be supplied to the first fluid supply portion 595 from each of the two flow passage portions of the third flow passage portion 593 and the fourth flow passage portion 594. Therefore, the oil O can be suitably supplied to the first fluid supply portion 595.

The present invention is not limited to the above-described embodiment, and other structures and other methods may be employed within the scope of the technical idea of the present invention.

The flow passage may have any configuration as long as the flow passage includes the first flow passage portion, the second flow passage portion, the third flow passage portion, and the first fluid supply portion. The fluid may flow in any direction in the flow passage. For example, the pump for feeding the fluid may cause the fluid to flow into the flow passage in a direction in which the fluid flows from the first fluid supply portion to the second flow passage portion via the third flow passage portion. The fluid flowing through the flow passage may be any kind of fluid.

The application of the drive apparatus to which the present invention is applied is not particularly limited. For example, the drive apparatus may be mounted on a vehicle for a purpose other than a purpose of rotating a drive shaft connected to a wheel, or may be mounted on a device other than the vehicle. The posture when the drive apparatus is used is not particularly limited. The center axis of the motor may be inclined with respect to the horizontal direction orthogonal to the vertical direction or may extend in the vertical direction. Features as described above in the present specification may be combined appropriately as long as no conflict arises.

The first fluid supply portion 94,294 does not necessary have the pipe shape. The first fluid supply portion 94,294 may be provided inside a side wall of the motor housing 11. In this case, the first fluid supply portion is a cavity provided inside the side wall of the motor housing 11. The first fluid supply portion extends into the inside of the side wall of the motor housing portion 11. The first fluid supply portion is connected to the third flow passage portion 93. The first fluid supply portion has at least one supply port in the side wall of the motor housing 11. The supply port is a through hole opened downward. The oil O in the first fluid supply portion 94,294 is discharged from the supply ports and supplied to the stator 22 from above. As a result, the first fluid supply portion 94,294 supplies the oil O to the stator 22.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive apparatus comprising:
a motor having a rotor rotatable about a center axis and a stator facing the rotor with a gap interposed therebetween;
a gear mechanism connected to the rotor;
a housing including a motor housing that accommodates the motor therein and a gear housing that is located on one side in an axial direction of the motor housing and accommodates the gear mechanism therein; and
a flow passage through which a fluid flows,
wherein
the rotor includes a hollow motor shaft extending in an axial direction,
the gear mechanism includes a hollow gear shaft connected to one side in an axial direction of the motor shaft,
the gear housing accommodates the fluid therein, and
the flow passage includes:
a first flow passage portion connecting an inside of the gear housing and an inside of the gear shaft;
a second flow passage portion at least a part of which is configured by an inside of the gear shaft and an inside of the motor shaft and connected to the first flow passage portion;
a third flow passage portion connected to a portion of the second flow passage portion on an other side in the axial direction; and
a first fluid supply portion connected to the third flow passage portion and located on a vertically upper side of the stator.

2. The drive apparatus according to claim 1, comprising a pump configured to feed the fluid,
wherein the pump causes the fluid to flow into the flow passage in a direction in which the fluid flows from the second flow passage portion to the first fluid supply portion via the third flow passage portion.

3. The drive apparatus according to claim 1, comprising a first reservoir and a second reservoir that are provided in an inside of the gear housing and can store the fluid,
wherein
a part of the first reservoir is configured by a bottom portion of the gear housing, and
the second reservoir is located vertically above the first reservoir and is provided in the flow passage.

4. The drive apparatus according to claim 3, wherein
the first flow passage portion connects the second reservoir and the second flow passage portion,
the second reservoir opens vertically upward, and
a lower end portion of the gear mechanism in a vertical direction is located in the first reservoir.

5. The drive apparatus according to claim 1, wherein
the motor shaft has a through hole radially penetrating a wall of the motor shaft from an inner peripheral surface of the second flow passage portion to an outer peripheral surface of the motor shaft.

6. The drive apparatus according to claim 5, wherein
a flow passage cross-sectional area of the second flow passage portion is larger than a flow passage cross-sectional area of the third flow passage portion.

7. The drive apparatus according to claim 5, wherein
a flow passage cross-sectional area of the second flow passage portion is smaller than a flow passage cross-sectional area of the third flow passage portion.

8. The drive apparatus according to claim 1, wherein
the motor shaft and the gear shaft are separated from each other and connected to each other by spline fitting.

9. The drive apparatus according to claim 1, comprising a bearing configured to rotatably support the motor shaft,
wherein the flow passage includes a second fluid supply portion that supplies the fluid to the bearing.

10. The drive apparatus according to claim 1, wherein
the first fluid supply portion is a pipe member extending in the axial direction.

11. The drive apparatus according to claim 1, wherein
the first fluid supply portion is a gutter member that opens vertically upward.

12. The drive apparatus according to claim 1, comprising a cooler configured to cool the fluid,
wherein the cooler is provided in the first flow passage portion.

13. A drive apparatus comprising:
a motor having a rotor rotatable about a center axis and a stator facing the rotor with a gap interposed therebetween;
a gear mechanism connected to the rotor;
a housing including a motor housing that accommodates the motor therein and a gear housing that is located on one side in an axial direction of the motor housing and accommodates the gear mechanism therein;
a hollow drive shaft connected to the gear mechanism and extending in an axial direction; and
a flow passage through which a fluid flows,
wherein
the gear housing accommodates the fluid therein, and
the flow passage includes:
a first flow passage portion connecting an inside of the gear housing and an inside of the drive shaft;
a second flow passage portion at least a part of which is configured by an inside of the drive shaft and connected to the first flow passage portion;
a third flow passage portion connected to a portion of the second flow passage portion on an other side in the axial direction; and
a first fluid supply portion connected to the third flow passage portion and located on a vertically upper side of the stator.

14. The drive apparatus according to claim 13, wherein
the rotor includes a hollow motor shaft extending in the axial direction, and
the drive shaft passes through an inside of the motor shaft.

15. The drive apparatus according to claim 14, wherein
the gear mechanism includes:
a first gear connected to the rotor;
a second gear that is rotatable about an intermediate shaft having different radial positions with respect to the center axis and meshes with the first gear;
a third gear that is rotatable about the intermediate shaft together with the second gear; and
a differential device that includes a fourth gear meshing with the third gear and rotates the drive shaft about a differential shaft,
the differential shaft coincides with the center axis.

16. The drive apparatus according to claim 13, comprising:
a pump configured to feed the fluid; and
a cooler configured to cool the fluid,
wherein the pump and the cooler are attached to the gear housing.

17. The drive apparatus according to claim 13, wherein
the third flow passage portion is provided in the motor housing.

18. The drive apparatus according to claim 17, wherein
the motor housing has an axial wall located on an other side in the axial direction of the stator, and
the third flow passage portion is provided in the axial wall.

19. The drive apparatus according to claim 13, wherein
the third flow passage portion connects an end portion on an other side in the axial direction of the second flow passage portion and an end portion on an other side in the axial direction of the first fluid supply portion.

20. The drive apparatus according to claim 13, wherein
the flow passage includes a fourth flow passage portion connecting an inside of the motor housing and the first fluid supply portion.
